(19) United States
(12) Patent Application Publication
(10) Pub. No.: US 2007/0289709 A1
(43) Pub. Date: Dec. 20, 2007

(54) METHOD FOR MANUFACTURING FLAME-RESISTANCE-TREATED DECORATIVE PLYWOOD

(75) Inventors: Vicwood Kee Ting CHONG, Hong Kong (CN); Richard Africa Yuet Ping CHONG, Hong Kong (CN); Yongnan HUANG, Suzhou (CN)

Correspondence Address: PERKINS COIE LLP, POST OFFICE BOX 1208, SEATTLE, WA, 98111-1208, US

(73) Assignees: Vicwood Kee Ting CHONG, Hong Kong (CN); Richard Africa Yuet Ping CHONG, Hong Kong (CN)

(21) Appl. No.: 11/764,093

(22) Filed: Jun. 15, 2007

(30) Foreign Application Priority Data
Jun. 15, 2006 (CN) 200610088045.4

(51) Int. Cl. C09J 5/02

(52) U.S. Cl. 156/324.4

(57) ABSTRACT

Method for manufacturing flame-resistance-treated decorative plywood by treating and permeating veneers with a flame retardant liquor. The flame retardant is able to penetrate into the interior of the veneer block, providing esterifications, aetherifications, and/or graft-copolymerifications to the hydroxy groups etc. within the veneers so that air, fire headstream, and inflammable gas are insulated or diluted to provide each veneer layer with flame-resistant capability. The heat decomposition process of the veneer is changed and inflammable capability controlled. The physical and chemical characteristics of the veneer is minimally altered after the treatment.

### RELATED APPLICATION

The present application claims priority from Chinese Patent Application No. CN200610088045.4 filed Jun. 15, 2006, contents and subject matter of which is incorporated herein by reference.

### TECHNICAL FIELD

The present invention relates to a method for manufacturing wood, specifically, for flame-resistant decorative material made of reconstituted natural wood.

### BACKGROUND

Raw materials of reconstituted decorative plywood are mainly plantation wood or forest products which are peeled (rotary cut) into veneers, dyed via various techniques such as mixing colours into the veneers, stacked by stratification, and compressed into moulds to form wood decorative materials which possess the same quality, design, and colour as the natural woods. This type of decorative material is a new wood compound made of natural or fast-growing trees such as Alamo or Paulownia, which have short growing periods and may easily be planted over large areas. This method may alleviate the shortage of natural timber species and provide a continuous use of natural wood resources.

A patent titled “A method for making man-made timber” (Patent number: ZL 00136528.2) was published on Nov. 23, 2005 by the State Intellectual Property Office of P. R. China and mentions “recombining veneers, then brushing an adhesive with an amount of 90-200 grams per square meter onto the surface of the veneers to form an adhesive layer using E0˜E1-type modified urea formaldehyde glue, which is flame-resistant as it is made of modified polyhexenyl acetate, modified melamine, or polyurethane.”

Although the veneers have been treated with a fireproof adhesive, the fireproof adhesive only remains on the surface layer of the boards so that the veneers have moderate flame-resistant capability. Treating blocks of reconstituted veneers with a fireproof adhesive may provide plywood with infinitesimal flame-resistant capability, because the adhesive may only penetrate into the surface layer of the reconstituted veneer and stay there; the interior of the reconstituted veneers, however, has no fireproofing capability.

### SUMMARY OF THE INVENTION

The present invention provides a solution for making flame-resistant veneers. The present invention provides improved methods to manufacture decorative plywood with a pre-eminent flame-resistant capability. Generally, the method of the present invention has the following steps:

(1) Treating natural veneers in the thickness of 0.2-6 mm or veneers made from lumber sawn in the thickness of about 2-50 mm with a flame-retardant adhesive at the concentrations of 0.5-100%, at the temperatures of 5-100° C., and under the pressure of 0-5 MPa, and allowing the flame-retardant adhesive to penetrate the veneers via vacuum-injection, immersion, brushing, or spraying;

(2) Gelatinizing the adhesive onto the veneers, stacking the veneers, pressing the resulting stack of veneers in a hot or cold press to form timber-shaped decorative plywood, and heating the veneers under high-frequency waves.

The flame retardant may be made of an organic or inorganic compound, or both. The inorganic flame retardant may be made from one or more of ammonium phosphate, 2-ammonium hydro-phosphate, ammonium sulphate, ammonium poly-phosphate, borax, or boracic acid. The organic flame retardant may be made from guanyl urea phosphate.

The present invention further provides another method for manufacturing flame-resistant decorative plywood including the following steps:

(1) Bleaching original veneers in the thickness of 0.2-6 mm or veneers made of lumber sawn into the thickness of 2-50 mm;

(2) Dyeing the veneers;

(3) Drying the veneers; and

(4) Gelatinizing an adhesive onto each veneer sheet to form an adhesive layer, stacking the gelatinized veneers, pressing the resulting block in a hot or cold press to form timber-shaped decorative plywood, and heating the veneers under high-frequency waves.

Prior to gelatinizing the adhesive onto the veneers, the veneers is treated with a flame-retardant liquor at a concentration of 0.5-100%, at the temperature of 5-100° C., and under the pressure of 0-5 MPa, the liquor is allowed to permeate into the veneers by vacuum-injection, immersion, brushing, or spraying. Ideally, the flame-retardant treatment may be carried out after bleaching and before drying the veneers. However, if the flame-retardant treatment is carried out after drying the veneers, the resulting flame-retardant-treated veneers must be dried once more.

A third method for manufacturing flame-resistant decorative plywood comprises the following steps:

(a) Bleaching original veneers in the thickness of 0.2-6 mm or veneers made of sawn lumber in the thickness of 2-50 mm;

(b) Dyeing the veneers;

(c) Drying the dyed veneers;

(d) Gelatinizing an adhesive onto each veneer to form an adhesive layer, stacking the gelatinized veneers in order, pressing them together in a hot or cold press to produce a block of decorative plywood, and heating the veneers by using high-frequency waves;

(e) Treating the veneers with a permeating flame-retardant liquor using vacuum-injection, immersion, brushing, or spray-liquor methods; and

(f) Slicing the decorative plywood block into veneer in accordance with set patterns and designs, gelatinizing an adhesive onto the veneers, stacking them in order, and pressing the resulting veneers in a hot or cold press to produce a reconstituted decorative plywood block. The slicing, gelatinizing, stacking, and pressing should be continuously repeated.

The flame retardant within veneers may provide reconstituted plywood with the flame-resistant capability. The traditional flame-resistance was provided to the entire block constituted of basic veneers, but the flame retardant was only able to penetrate into the surface layer of the reconstituted timber, so the flame-resistant was only found on the surface layer after being treated.

Each method of the present invention conducts flame-resistant treatment before the reconstitution process of veneers, that is to say, each veneer is treated with a flame-retardant liquor causing the liquor to permeate through the veneer, and then the treated veneers are reconstituted into decorative plywood. The flame retardant liquor may easily and thoroughly penetrate into the thin layer of veneers, causing esterification, aetherification, and/or graft-copolymerification to the hydroxy groups and other groups within the veneer layer so that the air, fire headstream, and inflammable gas are insulated or diluted in the veneers and each veneer is provided with the flame-resistant capability; the course of the heat decomposing process of the veneers is changed, and the combustion of the veneers is controlled. As the physical and chemical characteristics of the veneer are minimally altered after the flame-resistant treatment, the resulting decorative plywood meets the requirements of the eligible Flame-Resistant Construction Material, and the inflammable decorative plywood is successfully turned into fireproof material.

It is therefore an advantage of the present invention to provide a method for manufacturing a flame-resistant decorative plywood, where the veneers used as the basic material referred to in the method are permeated by a flame retardant which provides the decorative plywood with flame-resistant capability.

Additional features and advantages of the present invention are described in, and will be apparent from, the detailed description of the present invention.

### DETAILED DESCRIPTION AND PREFERRED EMBODIMENTS

The present invention relates to methods for manufacturing flame-resistant decorative plywood. A flame retardant in the plywood provides the plywood with flame-resistant capability. Therefore, the plywood needs to be treated thoroughly for flame resistance from the surface deep into its core. The flame-retardant liquor of the present invention may permeate throughout the veneers, which then are reconstituted to form plywood. Consequently, the final product, the plywood block, has pre-eminent flame-resistant capability.

The flame retardant may be in a liquid, condensed, or powder form, and before it is used, the flame retardant may be made into a liquor as described in more details below.

The flame retardant may be made from an organic, an inorganic compound, or both. The organic compound may be guanyl urea phosphate, and the inorganic compound may be one or more of ammonium phosphate, 2-ammonium hydro-phosphate, ammonium sulphate, ammonium poly-phosphate, borax, and boracic acid. The flame-retardant liquor may be kept at the concentration of 0.5-100%, at the temperature of 5-100° C., and under the pressure of 0-5 MPa, and may penetrate into the veneers via vacuum-injection, immersion, brushing, or spray-liquor to cause to permeate throughout the veneer layers.

Three preferred methods of the present invention are provided in further details below for manufacturing the flame-resistant decorative plywood using the methods of the present invention.

### The First Preferred Method:

The manufacturing of decorative plywood includes the following steps:

(1) Treating veneers with a flame-retardant liquor:

Mixing a flame retardant with water in the proportion of 1:1˜1:20 to form a flame-retardant liquor, and treating veneers by one of the following steps:

placing the liquor and veneers into a vessel at a volume proportion of 1:50˜50:1, while keeping the liquor within the vessel at the temperature of 5-100° C. and under the pressure of 0-5 Mpa, immersing the veneers in the liquor for 0.5-10 hours, then taking out the veneers; or

vacuumising the vessel before adding the flame-retardant liquor, using vacuum-injection to allow the liquor to permeate into the veneers; or

brushing or spraying the liquor onto the veneers, under normal temperatures or heating conditions, and within a certain time period which varies according to the method and required flame-resistant effect;

(2) Bleaching the veneers with a bleacher in a solution containing sulphur dioxide or hydrogen peroxide, or a mixed solution of thiourea dioxide at a concentration of 0.1˜15% and sodium hydroxide at a concentration of 50˜80% or 1.5˜70% without a stabilizer and maintained at the pH level of 7˜10;

(3) Dyeing the veneers, i.e., immersing the original or bleached veneers into an acid dye solution sorted according to three original colours of red, yellow, and blue, then cleaning the dyed veneers, the effect of dyeing depending on the temperature and concentration of the dye solution, the dyeing time, the proportion of veneers to dye solution, the thickness of each veneer, and the type of colouring agent added to the solution, where most often the dyeing is carried out at the temperature of 70˜100° C., at the concentration of 0.2˜1.5%, in a proportion of 5˜10:1, and within a dyeing time of 0.1˜20 hours;

(4) Drying the veneers via steam or high-frequency waves to control those veneers containing water at the concentrations of 8˜18%;

(5) Stacking the veneers, spreading an adhesive on both front and back, compressing the stacked veneers under the pressure of 30˜120 kilograms per square centimetre using moulds manufactured in accordance to computer design, cooling or heating them using high-frequency waves, and then slicing the veneer block according to a computer-designed pattern at an angle to form a plywood product or semi-product which is then stacked and compressed repeatedly until the decorative plywood is produced in accordance with a pre-designed pattern.

### The Second Preferred Method:

Decorative plywood is manufactured according to the below procedure:

(1) Bleaching the veneers;

(2) Dyeing the same veneers;

(3) Drying the dyed veneers;

(4) Treating the dried veneers with a flame retardant using the measures described at step (1) of the first method;

(5) Re-drying the veneers permeated with the flame retardant;

(6) Stacking the re-dried veneers, gelatinizing an adhesive onto both sides in order and then pressing the stacked veneers into a mould manufactured in accordance with computer design and cooling or heating them using high-frequency waves to form blocks of decorative plywood.

### The Third Preferred Method:

A third method is provided where all the steps are the same as the second method except that the step of the flame-resistant treatment of the veneers, as described in the previous two methods, is carried out between the bleaching and drying stages.

Frequently used flame retardant may, for the most part, be applied in the flame-resistant treatment of reconstituted decorative wood. The chemical components of the flame retardant generally consist of an inorganic or organic salt, or both. The inorganic salts prevalently used may be ammonium phosphate, 2-ammonium hydro-phosphate, ammonium sulphate, ammonium polyphosphate, borax, and boracic acid, and the organic salt may be guanyl urea phosphate. These salts cost little and may easily penetrate the wood material. Mixing some of them together may improve the quality of the flame retardant.

The flame retardant acts to fireproof the plywood by reducing the substance resulted from wood combustion. The flame retardant may decrease the speed of the flame moving along the surface of the plywood to alleviate the combustion of the surface and decrease the heat that is released with it, thus decreasing the potential combustion of the plywood. When timber products treated with flame retardant are heated to a high temperature, the flame retardant will lower the temperature of the area of degradation and change the decomposition character of the wood directly, increasing the amount of the coke at the surface, and decreasing the amount of volatile and inflammable gas.

### EXAMPLE

A flame-resistant plywood was made according to the method of the present invention, and the test of its flame-resistant capability was carried out as follows:

(1) Selecting flame retardant with the following characteristics:

Name of the product: SIRIONO 50 (type of above-mentioned retardant)

Batch number: 77050

Manufacturing site: Belgium;

(2) Dyeing veneers according to the following:

(a) Selecting AYOUS-type veneers sliced in the thickness of 0.75 mm;

(b) Concocting dye solution using the following: Acid yellow in a proportion of 0.10 gram per litre, acid red in a proportion of 0.007 gram per litre, and acid blue in a proportion of 0.005 gram per litre of dye solution used for undertone veneers, while acid red in a proportion of 0.004 gram per litre, and acid blue in a proportion of 0.006 gram per litre of dye solution used for fuscous veneers;

(c) Dyeing at a temperature of: 90±2° C., Keep for a period of 5 hours; then

(3) Treating veneers with a flame retardant according to the following steps:

(a) Immersing dyed veneer in the thickness of 0.75 mm into a liquor at a proportion of 1:3˜5 using a flame retardant and water for 2˜3 hours; then

(b) Drying the veneers, controlling the moisture content of the veneers at 10˜12%, and then recombining the veneers to form timber-shaped plywood according to any of the three aforementioned methods.

The test process used twenty veneers of 99-type white Beech at a dimension of approximately 1000 mm×190 mm×3 mm. The test items and results obtained were shown below:

| | | | tech- | | |
|---|---|---|---|---|---|
| | | | nology | test | |
| No. | test items | test method | index | result | conclusion |
| 1 | Shortest Length of | GB/T 8625-88 | >0 | 240 | qualified |
| | Unburned | | | | |
| | Veneer(mm) | | | | |
| 2 | Average Length of | GB/T 8625-88 | ≧150 | 282 | qualified |
| | Unburned | | | | |
| | Veneer(mm) | | | | |
| 3 | Average | GB/T 8625-88 | ≦200 | 126 | qualified |
| | Temperature of | | | | |
| | Smoke and | | | | |
| | Gas(° C.) | | | | |
| 4 | Height of | GB/T 8626-88 | <150 | 30 | qualified |
| | Flame(mm) | | | | |
| 5 | Level of Smoke | GB/T | ≦75 | 10 | qualified |
| | Density | 8627-1999 | | | |

The plywood product was measured by the State Flame-Resistant Construction Material Testing Centre of the P.R. China and all technology indices of the reconstituted flame-resistant decorative plywood passed the test and were acknowledged to have met the qualifications of flame-resistant material. In accordance with GB 8624-1997, the plywood product met the GB8624 B1 standard.

We claim:

1. A method for manufacturing flame-resistance-treated decorative plywood comprising the steps of
(a) Treating veneers with a flame retardant material that permeates throughout the veneers;
(b) Gelatinizing an adhesive onto each veneer sheet to form an adhesive layer, stacking the gelatinized veneers in order, and hot or cold pressing the stacked veneers to form timber-shaped decorative plywood.

2. The method according to claim 1, wherein the veneers are made of sawn lumber.

3. The method according to claim 2, wherein the sawn lumber is in thickness of about 2-50 mm.

4. The method according to claim 2, wherein the veneers are in thickness of about 0.2-6 mm.

5. The method according to claim 1, wherein the heat pressing of step (b) is conducted via high-frequency waves.

6. The method according to claim 1, wherein the veneers are permeated with flame resistant material.

7. The method according to claim 1, wherein the flame retardant material comprises an organic compound, an inorganic compound, or both; and
Wherein the inorganic compound is ammonium phosphate, 2-ammonium hydro-phosphate, ammonium sulphate, ammonium poly-phosphate, borax, or boracic acid, and the organic compound is guanyl urea phosphate.

8. The method according to claim 1, wherein the veneers are treated with the flame retardant material via vacuum-injection, immersion, brushing, or spray treatment.

9. The method according to claim 1, wherein the flame retardant material is made of a flame retardant that is dissolved in a liquor at a concentration of 0.5-100%, at a temperature of 5-100° C., and under a pressure of 0-5 MPa.

10. A method for manufacturing flame-resistance-treated decorative plywood comprising the steps of
(a) Bleaching veneers;
(b) Dyeing the veneers;
(c) Drying the veneers; and
(d) Gelatinizing an adhesive onto each veneer to form an adhesive layer, stacking the gelatinized veneers in order, and hot or cold pressing the resulting veneers to produce timber-shaped decorative plywood;
wherein prior to step (d), the veneers are treated with a flame retardant which permeates throughout the veneers.

11. The method according to claim 10, wherein the flame-retardant treatment is carried out between step (a) and (c).

12. The method according to claim 10, wherein the flame-retardant treatment is carried out after step (c) and dried prior to step (d).

13. The method according to claim 10, wherein the flame-retardant treatment is carried out before step (a).

14. The method according to claim 10, wherein the veneers are made of sawn lumbers.

15. The method according to claim 14, wherein the veneers are sawn lumbers in thickness of about 2-50 mm.

16. The method according to claim 14, wherein the veneers are in thickness of about 0.2-6 mm.

17. The method according to claim 10, wherein the hot pressing of step (b) is conducted by using high-frequency waves.

18. The method according to claim 10, wherein the flame retardant comprises an organic, an inorganic compound, or both; and
wherein the inorganic compound is ammonium phosphate, 2-ammonium hydro-phosphate, ammonium sulphate, ammonium poly-phosphate, borax, or boracic acid, and the organic compound is guanyl urea phosphate.

19. The method according to claim 10, wherein the veneers are treated with the flame retardant via vacuum-injection, immersion, brushing, or spray treatment.

20. The method according to claim 10, wherein the flame retardant is dissolved in a liquor at a concentration of 0.5% to 100%, at a temperature of 5-100° C., and under a pressure of 0-5 MPa.

21. A method for manufacturing flame-resistance-treated decorative plywood comprising the steps of
(a) Bleaching veneers;
(b) Dyeing the veneers;
(c) Drying the veneers;
(d) Gelatinizing an adhesive onto each veneer to form an adhesive layer, stacking the veneers in order, and hot or cold pressing the resulting veneers to produce timber-shaped decorative plywood;
(e) Slicing the timber-shaped decorative plywood into veneers according to pre-designed patterns, gelatinizing an adhesive onto each veneer to form an adhesive layer, stacking the veneers in order, hot or cold pressing the resulting stacked veneers to form timber-shaped decorative plywood, and repeating the process several times over,
wherein the veneers is treated with a flame retardant that permeates into the veneers before being gelatinized in step (e).

22. The method according to claim 21, wherein the veneers are made of sawn lumbers.

23. The method according to claim 22, wherein the veneers are sawn lumbers in thickness of about 2-50 mm.

24. The method according to claim 22, wherein the veneers are about 0.2 mm to 6 mm thick.

25. The method according to claim 21, wherein the hot pressing in step (e) is conducted by high-frequency waves.

26. The method according to claim 21, wherein the flame retardant is dissolved in a liquor at a concentration of 0.5-100%, at a temperature of 5-100° C., and under a pressure of 0-5 MPa.

27. The method according to claim 21, wherein the flame retardant comprises an organic or inorganic compound, or both; and
wherein the inorganic compound is ammonium phosphate, 2-ammonium hydro-phosphate, ammonium sulphate, ammonium poly-phosphate, borax, or boracic acid, and the organic compound is guanyl urea phosphate.

28. The method according to claim 21, wherein the veneers are treated with the flame retardant via vacuum-injection, brushing, or spray treatment.
